(19) United States
(12) Patent Application Publication
(10) Pub. No.: US 2023/0380399 A1
(43) Pub. Date: Nov. 30, 2023

(54) LIVEWELL OPERATION AND CONTROL FOR A WATERCRAFT

(71) Applicant: Navico Holding AS, Egersund (NO)

(72) Inventor: Jeremiah D. Clark, Tulsa, OK (US)

(21) Appl. No.: 17/828,317

(22) Filed: May 31, 2022

(51) Int. Cl. A01K 99/00; G01B 11/02

(52) U.S. Cl. CPC A01K 99/00; G01B 11/02

(57) ABSTRACT

A marine electronics device for a watercraft is presented herein. The marine electronic device comprises a user interface comprising a display, a processor and a memory including computer program code. The computer program code causes the processor to receive data associated with a fish, including an indication of a characteristic value of weight of the fish or length of the fish. Each fish within the livewell is assigned a culling tag and has a stored characteristic value. A threshold characteristic amount associated with a livewell is determined, wherein the threshold characteristic is equal to a minimum characteristic value of a fish within the livewell. If a characteristic value of a caught fish exceeds the threshold characteristic amount, a culling tag is assigned to the fish.

### FIELD OF THE INVENTION

Embodiments of the present invention relate generally to methods and systems for aiding in management of fish in a livewell.

### BACKGROUND OF THE INVENTION

Fishermen may store fish caught during a fishing trip or during a fishing tournament in a livewell of a watercraft. Generally, a livewell comprises a tank that may be filled with water to keep the fish alive while the watercraft is on the water. Some livewells are configured to be filled prior to leaving the shore, such as from an external water source, e.g. hose, bucket, or the like, while other livewells may fill from the body of water which the watercraft is in, such as by using a fill pump. Fishermen may manually activate the pump to fill the livewell or cause recirculation of the water within the livewell.

Fishermen may be constrained by the number of fish held within the livewell. This may occur, for example, due to state or tournament regulations. While on the body of water, fisherman may desire to have the best fish counting towards the inventory quota. There exists a need for ways to easily identify and manage the best combination of fish.

### BRIEF SUMMARY OF THE INVENTION

Once a fish is caught, a fisherman may measure a characteristic value of the fish, such as the weight and/or length of the caught fish. This may be done manually and/or through one or more automated machines. Once the characteristic value is determined, fishermen typically rely on their memory or use manual notes (e.g., notebooks, logbooks, etc.) to record the characteristic value(s) of each fish, and position the fish within the livewell. For example, a fisherman may record the weight of each fish or the length of each fish caught. The fishermen may also assign a corresponding culling tag that is specific to that fish. This too may be recorded along with the characteristic value(s). As with any manual operation, the ability to introduce human error is high. For example, a fisherman may erase the wrong fish data, incorrectly tag the fish, or release the incorrect fish thereby mixing up the information.

The present invention is directed towards various systems and methods for providing an interactive database for the fisherman to obtain, record and view the current characteristic values of the fish within the livewell. The system may include a marine electronics device, and may optionally be connected, either wired or wirelessly to measuring and identifying devices (e.g., scales, cameras, etc.). Upon catching a fish, the system may receive characteristic data of the fish, such as characteristic value(s) (e.g., length and/or width of the fish) and other data surrounding the fish (e.g., the location of the catch, weather conditions for the catch, the bait used, etc.). A characteristic value, such as the length and/or width of the caught fish, may then be automatically compared to the characteristic value of the one or more fish within the livewell. When the total number of fish within the livewell is greater than an inventory threshold, the system may determine if the characteristic value of the caught fish is greater than the least of the characteristic values of the fish within the livewell, and indicate a swap fish within the livewell to be swapped for the caught fish. The system may archive the characteristic data of the swap fish, and update the system with the characteristic data of the caught fish. Thus, allowing the fisherman to easily view and swap fish within the livewell to efficiently and effectively manage fish within the livewell.

An example embodiment provides a marine electronics device for a watercraft. The marine electronics device comprises a user interface comprising a display, a processor and a memory including computer program code. The computer program code is configured to, when executed, cause the processor to receive data associated with a fish. The received data includes an indication of a characteristic value of the fish, wherein the characteristic value is one of weight of the fish or length of the fish. The computer program code is further configured to determine a threshold characteristic amount. The threshold characteristic amount is associated with a livewell configured to hold one or more fish. Each of the one or more fish held by the livewell has a stored characteristic value and is associated with a culling tag. The threshold characteristic amount is equal to a minimum value of the stored characteristic values associated with the one or more fish held by the livewell. The computer program code is further configured to determine if the characteristic value of the fish exceeds the threshold characteristic amount. The computer program code is further configured to assign a culling tag associated with the characteristic value of the fish to the fish. The computer program code is further configured to cause, on the display, indication of the culling tag and the stored characteristic value corresponding to the culling tag of each of the one or more fish held by the livewell.

In some embodiments, the computer program code may further be configured to determine a maximum number of fish to be associated with the livewell and determine if an addition of the fish exceeds the maximum number of fish. The computer program code may further indicate, on the display, the culling tag associated with a swap fish when the addition of the fish exceeds the maximum number of fish. The swap fish has a stored characteristic value corresponding to the threshold characteristic amount.

In some embodiments, the computer program code may further be configured to receive an indication of a release of the swap fish, and archive the data associated with the swap fish. In some embodiments, the maximum number of fish is received from a manual entry. In some embodiments, the maximum number of fish is received from a tournament organizer.

In some embodiments, the processor may be in data communication with a measuring device. In some embodiments, the measuring device may provide data associated with the fish, including the characteristic value.

In some embodiments, the computer program code may further be configured to determine a current location of the watercraft associated with a location where the fish is caught and mark a waypoint associated with the location of the watercraft when the fish is caught.

In some embodiments, the computer program code may further be configured to receive an indication of an oxygen level of water within the livewell from one or more oxygen sensors, and cause a pump associated with the livewell to recirculate water in the livewell in response to determining that the oxygen level is below a predetermined oxygen threshold.

In some embodiments, the computer program code may further be configured to receive an indication of a temperature of water within the livewell from one or more temperature sensors, and cause a pump associated with a livewell to recirculate water in the livewell in response to determining that the temperature of the water is outside a predetermined temperature threshold.

In some embodiments, the computer program code may further be configured to cause, on the display, presentation of an indication of at least one livewell characteristic on the display. The at least one livewell characteristics may be one of an oxygen level, a temperature, and the threshold characteristic amount.

In some embodiments, the marine electronics device may comprise a camera. The computer program code may be further configured to receive an image of the livewell from the camera. The computer program code may be further configured to cause, on the display, presentation of the image. In some embodiments, the presentation of the image may include presentation of the at least one livewell characteristic

In some embodiments, the culling tag may define an identifying characteristic. The identifying characteristic may be is easily identifiable between the display and the livewell. In some embodiments, the identifying characteristic may be at least one of a color or a number.

In some embodiments, the computer program code may further be configured to determine a first user associated with a first livewell and a second user associated with a second livewell. The computer program code may further be configured to receive indication of the first user or the second user and associate the received fish data with the indicated first or second user.

In some embodiments, the computer program code may further be configured to determine a total characteristic value. In some embodiments, the total characteristic value may be a sum of the stored characteristic values of the one or more fish held by the livewell. The computer program code may further be configured to export the total characteristic value to a database. In some embodiments, the database may be associated with a tournament.

In some embodiments, the computer program code may be further configured to cause, on the display, each of the stored characteristic values of the one or more fish held by the livewell and order the presentation of the one or more fish based on the stored characteristic values.

In another example embodiment a non-transitory computer-readable medium having stored thereon a plurality of computer-executable instructions is provided. The computer-executable instructions, when executed cause a processor to receive data associated with a fish, including an indication of a characteristic value of the fish. The characteristic value is one of weight of the fish or length of the fish. The computer-executable instructions further determine a threshold characteristic amount. The threshold characteristic amount is associated with a livewell configured to hold one or more fish. Each of the one or more fish held by the livewell has a stored characteristic value and is associated with a culling tag. The threshold characteristic amount is equal to a minimum value of the stored characteristic values associated with the one or more fish held by the livewell. The computer-executable instructions further assign a culling tag to the fish when the characteristic value exceeds the threshold characteristic amount, and cause, on a display indication of the culling tag associated with the fish.

In some embodiments, the computer-executable instructions may further be configured to determine a swap fish from the one or more fish. The swap fish may have the stored characteristic value corresponding to the threshold characteristic amount. The computer-executable instructions may further be configured to cause, on the display, presentation of tag information corresponding to the swap fish. In some embodiments, the tag information may be at least one of a color or a number.

In some embodiments, the computer-executable instructions may further be configured to cause an indication when the received data associated with the fish is less than the threshold characteristic amount. In some embodiments, the indication may alert a user to release the fish.

In some embodiments, the computer-executable instructions may further be configured to cause, on the display, presentation of the stored characteristic value of each of the one or more fish held by the livewell and the culling tag corresponding to each of the one or more fish. In some embodiments, each of the culling tags displays an identifying characteristic. In some embodiments, the identifying characteristic may be at least one of a color or a number. In some embodiments, an order of the presentation of the stored characteristic values is based on a relative value of the stored characteristic value.

In yet another example embodiment a method is provided. The method comprises determining a characteristic value of a caught fish. The characteristic value is one of weight of the fish or length of the fish. The method further comprises determining a threshold characteristic amount. The threshold characteristic amount is associated with a livewell configured to hold one or more fish each one or more fish having a stored characteristic value and being associated with a culling tag. The threshold characteristic amount is equal to a minimum value of the stored characteristic values associated with the one or more fish held by the livewell. The method further comprises determining if the characteristic value of the fish exceeds the threshold characteristic amount. The method further comprises assigning a culling tag to the fish and associating the culling tag with the characteristic value of the fish. The method further comprises indicating a swap fish having the threshold characteristic amount. The method further comprises causing, on a display, indication of the culling tag and the stored characteristic value corresponding to the culling tag of each of the one or more fish held by the livewell.

### BRIEF DESCRIPTION OF THE DRAWINGS

Having thus described the invention in general terms, reference will now be made to the accompanying drawings, which are not necessarily drawn to scale, and wherein:

FIG. 1 illustrates an example watercraft in accordance with some embodiments discussed herein;

FIG. 2 illustrates a representation of an example livewell with fish including culling tags in accordance with some embodiments discussed herein;

FIG. 3 illustrates example culling tags, in accordance with some embodiments discussed herein;

FIG. 4A illustrates an example display, presenting an example characteristic value display, in accordance with some embodiments discussed herein;

FIG. 4B illustrates the example display, presenting example controls for operating and controlling the livewell, in accordance with some embodiments discussed herein;

FIG. 4C illustrates the example display, presenting an example image of fish and conditions in the livewell on the watercraft, in accordance with some embodiments discussed herein;

FIG. 5A illustrates the example display, presenting a chart with example waypoints, in accordance with some embodiments discussed herein;

FIG. 5B illustrates the example display, presenting a highlighted waypoint on the chart and an image of the fish caught at a waypoint, in accordance with some embodiments discussed herein;

FIG. 5C illustrates the example display, presenting a highlighted waypoint on the chart and the corresponding sonar image of the fish caught at the highlighted waypoint, in accordance with some embodiments discussed herein;

FIG. 5D illustrates the example display, presenting the chart and an example leaderboard, in accordance with some embodiments discussed herein;

FIG. 6 illustrates a block diagram of an example marine system, in accordance with some embodiments discussed herein; and

FIGS. 7-8 illustrate flowcharts of example methods of providing for automated fish and livewell control, in accordance with some embodiments discussed herein.

### DETAILED DESCRIPTION

Exemplary embodiments of the present invention now will be described more fully hereinafter with reference to the accompanying drawings, in which some, but not all embodiments of the invention are shown. Indeed, the invention may be embodied in many different forms and should not be construed as limited to the exemplary embodiments set forth herein; rather, these embodiments are provided so that this disclosure will satisfy applicable legal requirements. Like reference numerals refer to like elements throughout.

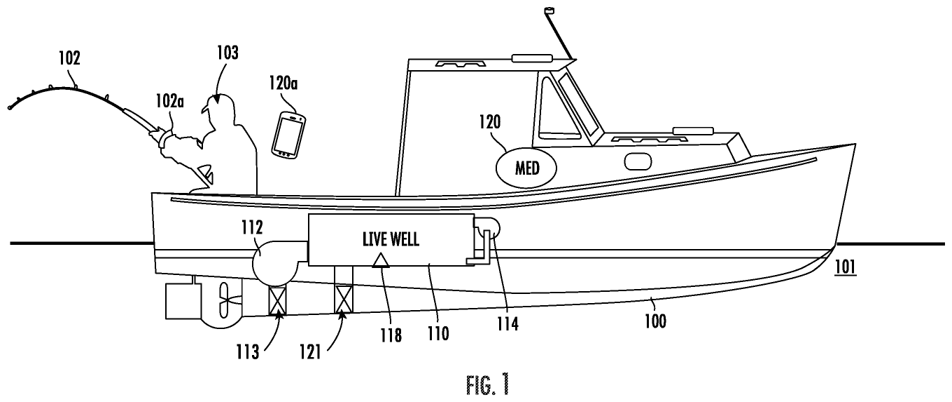

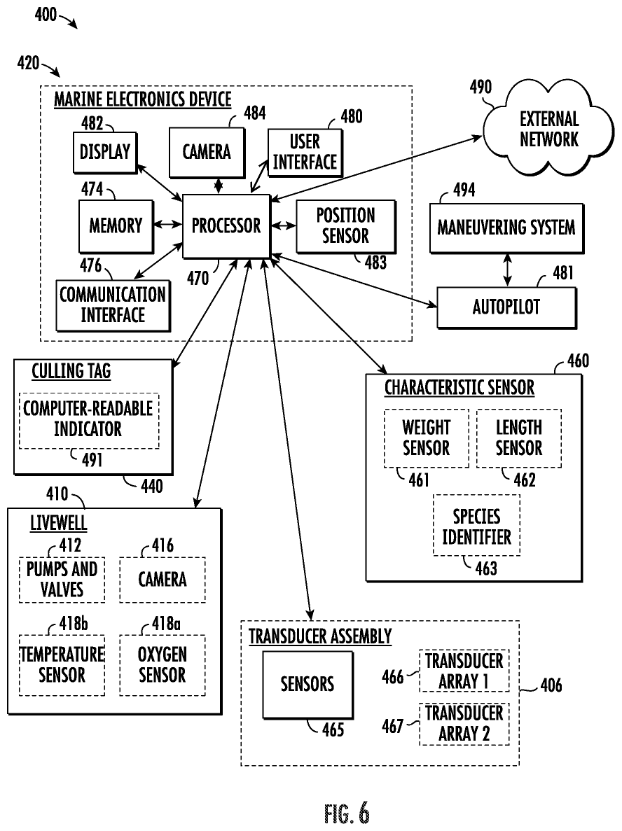

FIG. 1 illustrates an example watercraft, e.g. watercraft 100, configured to traverse a marine environment, e.g. body of water 101. The watercraft 100 may include a marine electronic device (MED) 120 disposed on and/or proximate to the watercraft. The watercraft 100 may be a surface watercraft, a submersible watercraft, or any other implementation known to those skilled in the art. The marine electronic device 120, which is described in reference to FIG. 6 below, may be utilized to trigger one or more events or other functionality on the watercraft 100 in response to predetermined criteria, such as a fish catch. Example events, which may be triggered based on the occurrence of predetermined criteria, are discussed herein.

In an example embodiment, a watercraft 100 may include one or more livewells 110 configured to be filled with water for live storage of fish, such as during a fishing expedition or fishing tournament. The livewell 110 may be sized based on the type of watercraft 100, e.g. watercraft size and intended use, and range, for example, from about 5 gallons to about 40 gallons, or more.

In an example embodiment, the fisherman 103 may receive an indication of a first fish catch from a motion sensor 102a, such as may be associated with a fishing rod 102, a wrist of the fisherman 103, among others. The motion sensor 102a may be embodied in a grip or reel of the fishing rod 102, in a wrist strap, smart watch, or other wearable computing device. The motion sensor 102a may sense various movements associated with the fisherman 103 and/or the fishing rod 102. The motion sensor 102a and/or the marine electronic device 120 may be configured to identify motion indicative of fish catch, for example, a jerk indicative of setting a hook and/or a rotating motion indicative of reeling in a fish. Further information regarding some example motion sensors may be found in U.S. Ser. No. 14/032,319, published as U.S. Publication No. 2015/0057968, which is assigned to the Assignee of this application and incorporated herein by reference in its entirety.

Additionally or alternatively, the indication of a fish catch may be input by the fisherman 103, such as using a user interface of the marine electronic device 120 and/or a mobile computing device 120a (e.g., a tablet computer, personal data assistant (PDA), smart phone, or the like). The fisherman 103 may select an icon, button, or the like indicating a fish catch.

In some embodiments, in response to the indication of a fish catch, the marine electronic device 120 may cause the livewell 110 to automatically fill, such that it is ready to receive a fish for live storage. The marine electronic device 120 may be configured to monitor and/or control operation of a fill pump 112 and/or a fill valve 113. In an example embodiment, the marine electronic device 120 may control a supply of power to the fill valve 113 and/or the fill pump 112, such as a relay, transistor, or the like, in a power supply line connected to the fill pump 112 and/or fill valve 113. In some embodiments, the livewell 110 comprises a purge valve 121 configured for at least partially purging the contents of the livewell 110, such as for storage of the watercraft and/or for subsequent refilling of the livewell 110.

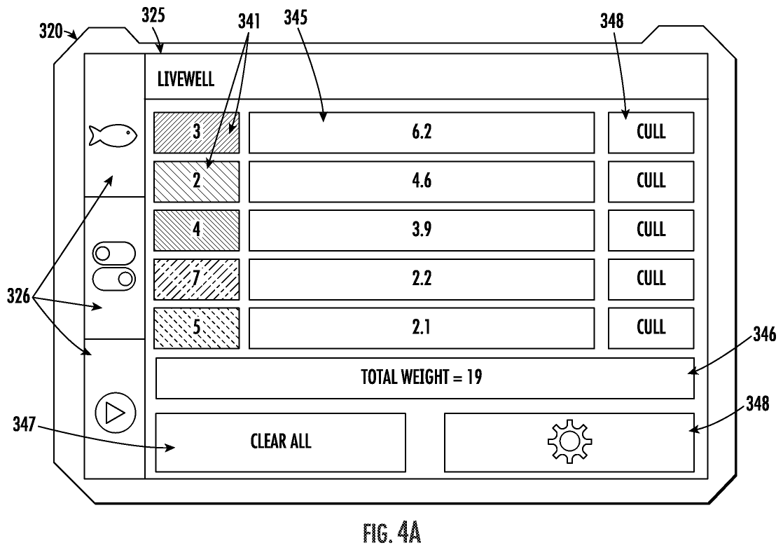

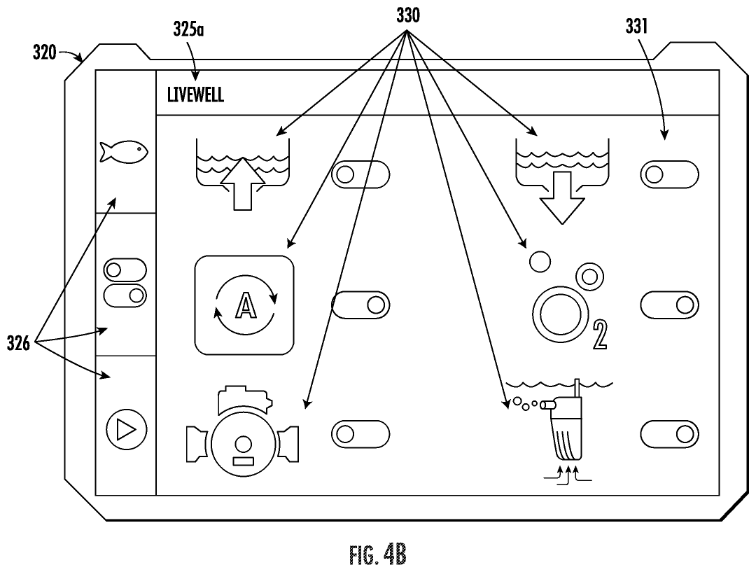

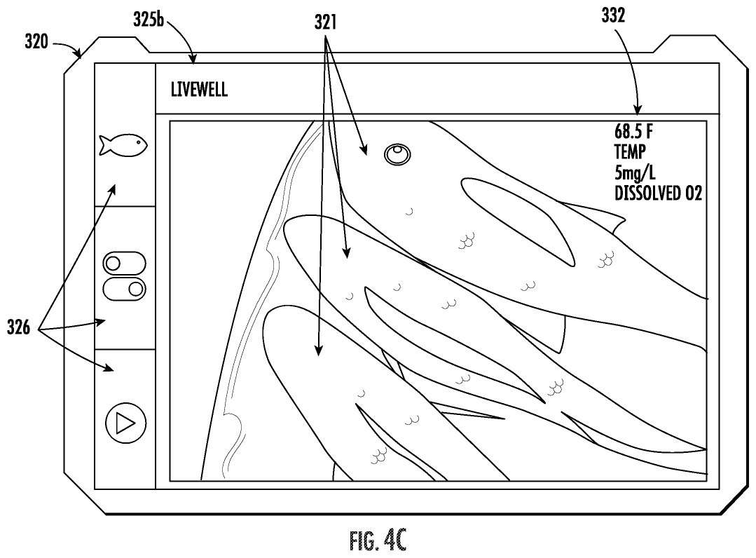

In some embodiments, the livewell 110 may include a recirculation pump 114. The marine electronics device 120 may be configured to cause the water in the livewell 110 to recirculate. In some embodiments, the marine electronics device 120 may cause the water to recirculate in response to a subsequent catch indicated by the motion detector 102a. In some embodiments, the livewell 110 may comprise at least one sensor 118, as discussed further with reference to FIG. 4B.

In some example embodiments, the marine electronic device 120 may receive one or more indications of fish characteristic data for a fish associated with the fish catch. The fish characteristic data may, in some embodiments, be manually entered by a fisherman 102 using a user interface of the marine electronic device 120 and/or the mobile computing device 120a. The fish characteristic data may include characteristic values of the fish, for example, the length of the fish, weight of the fish, species of the fish, or other data associated with the fish or the catch of the fish (e.g., location of the catch, weather during the fish catch, bait used, etc.). In some embodiments, the fish characteristic data may be entered into one or more data fields using the user interface, selected by drop down or scrolling menus, or other suitable data entry method.

Additionally or alternatively, one or more sensors associated with the watercraft 100 may be used, such as a measurement sensor configured to measure the weight of the fish (e.g., with a connected scale or a wireless scale), or measure the length of the fish (e.g., with an optical or tape based measuring device). In some embodiments, the fisherman 102 may read the one or more sensors, and manually enter the output into the marine electronics device. For example, a scale may measure the weight of the fish as 3.9 pounds, and the fisherman 102 may enter the weight in the corresponding characteristic value input. In some embodiments, the one or more sensors may be in data communication with the marine electronics device 120 via wireless or a hardwire connection, wherein the one or more sensors may transmit the fish characteristic data to the marine electronic device 120 to be correlated with a fish catch such that user error is reduced.

In some embodiments, the marine electronic device 120 and/or a fisherman 102 may cause one or more cameras to capture an image of the fish. The images of the fish may include a measurement device, such as a ruler, tape measure, calibrated length marker, or the like. The marine electronic device 120 may determine a length of the fish and/or a weight of the fish to be included in the fish characteristic data accordingly. In some example embodiments, the marine electronic device 120 may compare the fish to one or more stored fish color or shape profiles and select or recommend a fish type or species to be included in the fish data. In some embodiments, fish length measurement may be performed automatically, such as described further in U.S. application Ser. No. 15/150,898, entitled “Systems And Associated Methods For Measuring The Length Of A Fish”, issued as U.S. Pat. No. 9,928,611, which is assigned to the Assignee of this application and incorporated by reference herein in its entirety.

In some embodiments, in response to an indication of a caught fish, the system may mark a waypoint corresponding to the location of the watercraft 100 at the time of the catch. In some embodiments, the waypoint may be stored with characteristic data associated with the fish, such that a user may see the location of the catch when reviewing the results.

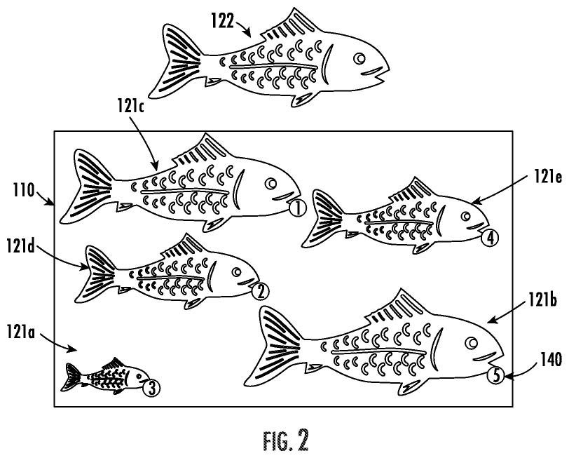

The livewell of the watercraft 100 may be configured to hold one or more fish. In some embodiments, as illustrated in FIG. 2, one or more fish 121a-121e may be present within the livewell 110. To differentiate between each of the one or more fish 121a-121e, a culling tag 140 may be assigned to each fish. The culling tag 140 may be correlated to the stored fish characteristic data.

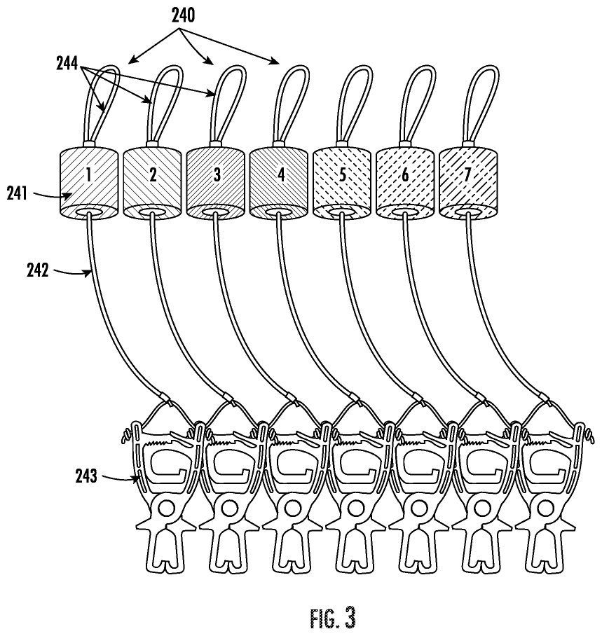

FIG. 3 illustrates a plurality of culling tags 240. Each of the culling tags 240 is releasably attachable to a fish. In some embodiments, the culling tag 240 may define an attachment end 243, and an upper end 244 connected by a connector 242. In some embodiments, the attachment end 243 may define a clamp, a hook, a clip, or similar, designed to be secured to the fish. In some embodiments, the attachment end 243 may be attached to a fin or a tail of the fish, while in other embodiments, the attachment end 243 may be secured within the mouth of the fish.

In some embodiments, the upper end 244 may be shaped in a loop to secure the culling tag 240 to a hook or similar within the livewell. In some embodiments, the upper end 244 may include a hook or another attachment mechanism to secure the culling tag 240 to the livewell.

In some embodiments, the culling tag 240 may include an identifier 241 adjacent the upper end 244. In some embodiments, the identifier 241 is a floatation device, for example a hollow ball, Styrofoam, or other buoyant material. The identifier 241 may be colored and/or patterned for easy identification. In some embodiments, the identifier 241 may include an alpha numerical reference and/or a combination of a color and/or pattern and an alpha numerical reference. For example, the identifier 241 may include yellow stripes and be labeled with the number 1.

In some embodiments, the identifier 241 may include a computer readable identifier, for example, a chip or a barcode. In some embodiments, the computer readable identifier may be scanned by the marine electronics device (or other user device) to correlate the fish characteristic data with the culling tag 240 and/or retrieve the fish characteristic data about the attached fish. In some embodiments, the computer readable identifier may be used (e.g., read) to unlock the data set to allow the fisherman to input data corresponding to a new fish, thus, preventing incorrect data from being input, and/or erased.

In some embodiments, for example, a state, tournament, or body of water may put an inventory threshold on the maximum number of fish a fisherman is allowed to hold on the watercraft at a time. Thus, the fisherman may need to release one or more fish to swap with a swap fish within the livewell. In such situations the fisherman may desire to maximize the quality of the inventory of fish within the livewell. In some embodiments, the quality may correspond to a characteristic value, for example, weight and/or length of the fish in the livewell, while in other embodiments, the quality may correspond to a species of fish. Thus, the fisherman may utilize a user interface to record and monitor the fish characteristic data, including characteristic values, to determine the swap fish to release and the fish to keep within the livewell.

In an example embodiment, with reference to FIG. 4A, a marine electronics device 320 may be configured to present on a display 325, a culling page including presentation of identifiers 341 of a culling tag (e.g., 240 illustrated in FIG. 3) and corresponding characteristic values 345, for example, weight or length. In some embodiments, the display 325 may be configured to present the characteristic values 345 and may include other fish characteristics stored within the memory of the marine electronics device 320.

A fisherman may desire to see, order and/or organize the known characteristic value data of the fish held within the livewell (e.g., 121a-e of FIG. 2). In some embodiments, the marine electronics device 320 may be used to correlate, store, and present characteristic data to the fisherman corresponding to the fish within the livewell, and to compare the stored characteristic values of the one or more fish within the livewell with fish characteristic data of a first caught fish, such as the characteristic value.

In some embodiments, the marine electronics device 320 may present the identifiers 341 in a rank order, for example, largest characteristic amount 345 (e.g., identifier 3) to smallest characteristic amount 345 (e.g., identifier 5) or vice versa. The presentation of the identifiers 341 may indicate to the fisherman the identifier 341 corresponding to the fish with the largest and/or smallest characteristic amount 345.

In some embodiments, the fisherman may need to cull and/or release the fish exhibiting the lowest characteristic value, for example, when a fishing tournament or law only allows a certain number of fish in a livewell at a time, e.g., an inventory threshold. Thus, presenting the identifiers 341 in such an order allows the fisherman to easily see which identifier corresponds to the smallest characteristic value 345, and remove the fish from the livewell upon catching another fish with a larger characteristic value. In some embodiments, the marine electronics device 320 may determine which fish is suggested to be swapped with the recently caught fish and present such an indication to the user.

In some embodiments in which the number of fish, including the caught fish, exceeds the inventory threshold, the marine electronic device 120 may be configured to determine a swap fish from among the fish in the livewell and, in some cases, the caught fish. The swap fish may be determined based on the characteristic value. In some embodiments, the swap fish may be the least desirable fish of all of the fish, including the caught fish, such as the smallest fish, e.g., smallest weight and/or length (e.g., 121a in FIG. 2). In some embodiments, the swap fish may be the smallest fish of a type of fish or a species of fish.

In some embodiments, the system may determine the swap fish defining the lowest characteristic value 345 and assign the stored characteristic value of the swap fish as a threshold characteristic amount. Thus, when a fish is caught, the system may compare the caught fish data with the threshold characteristic amount. If the characteristic value of the caught fish is greater than the threshold characteristic amount, the system may produce an indication that the characteristic value of the caught fish exceeds the threshold characteristic value. The system may present the indicator of the swap fish, and cull the swap fish data, and the culling tag may be assigned to the caught fish.

In some embodiments, the system may include more culling tags than the allowed number of fish within the livewell to allow for simultaneous culling of the swap fish and catching of the caught fish.

Prior to marking the caught fish with the culling tag, the system may present the fisherman with an indication of the identifier 341 of the fish with the threshold value (e.g., the lowest characteristic value of the currently held fish). The fisherman may instruct the system to cull the data of the fish corresponding to the threshold value by selecting the culling feature 348 on the display 325. In some embodiments, the system may be configured to cull the fish data from the display 325, while maintaining the data in a memory buffer or at a server so that the fisherman may retain the characteristic data associated with the culling tag, including for example, location, air temperature, water temperature, time, sonar images, photographs of the fish and/or location, weight and/or length of the fish, and other data which may be correlated to the culling tag.

In some embodiments, the marine electronics device may be configured to present a total characteristic value 346 of the fish contained within the livewell. The total characteristic value 346 may be the sum of the characteristic values 345 of each fish contained within the livewell. For example, in a fishing tournament, the fisherman may be tasked with catching five fish with the greatest total weight. Thus, the characteristic value 345 would be weight, and the system may sum the characteristic values associated with each of the identifiers 341 and generate the total characteristic value 346 of the total weight of the fish within the livewell.

In some embodiments, the system may include a clear all 347 function. The clear all function 347 may be configured to cull all of the fish data at once. In some embodiments, the clear all function may remove the data from the display 325, while maintaining the data in a server, or other memory. In some embodiments, the clear all function 347 may be time sensitive, and only useable after a specified amount of time. For example, the clear all function 347 may be locked until an hour after a fishing tournament ends. In some embodiments, the display 325 may not include a clear all function 347, but rather clear the data queue when the system is restarted or shut down.

In some embodiments, display may include a settings function 348. The settings function 348 may allow the fisherman to toggle between characteristics, number of fish, number of characteristic displayed, display settings, and other settings associated with marine electronics devices.

In some embodiments, the number of identifiers 341 presented on the display 325 indicates the maximum number of fish allowed in each livewell. In some embodiments, the fisherman may manually enter the number of fish allowed by local and/or tournament rules, while in other embodiments the marine electronics device 325 may be connected to a server containing the inventory threshold of fish in the livewell, and the server may populate the culling page accordingly. For example, a fishing tournament may determine the maximum number of fish allowed in each livewell and populate each participants marine electronics device 325 with the maximum number of identifiers 341. In some embodiments, a tournament may design a distinct culling page for the tournament such that the fisherman may download the page defining the tournament rules and regulations prior to the start of the tournament. Thus, rather than having the fisherman manually enter the maximum number of fish, the tournament may provide (e.g., via a server) the information, thereby preventing human error.

In some embodiments, the marine electronics device 320 may enable toggling between display pages. The marine electronics device 320 may include toggle buttons 326. In some embodiments, the toggle buttons 326 may change the display page, and/or bring the display into a split screen to present different information on to the display 325.

In some embodiments, with reference to FIG. 4B, the marine electronics device may include a livewell setting display page 325a. In some embodiments, the livewell setting display page 325a may include multiple features related to the livewell and functions thereof. For example, the fisherman may be able to increase the water level in the livewell, lower the water level in the livewell, recirculate the water in the livewell, oxygenate the water in the livewell, use the recirculation pump, and/or intake water from the body of water. In some embodiments, each of these uses may comprise a switch 331 adjacent the icon. Changing the position on the switch 331 may engage or disengage the feature. Further, in some embodiments, engagement of one switch 331 may disengage another. For example, engaging the switch to increase the water level in the livewell may disengage the switch to decrease the water level of the livewell.

In some embodiments, changing the position 331 may turn the setting on for a cycle. For example, the recirculation pump may be switched to the on position. In the on position, the recirculation may run for a determined amount of time to recirculate the water within the livewell and cease recirculation after the determined amount of time.

The livewell may be positioned in the watercraft away from the fisherman and/or away from the marine electronics device 320. In some embodiments, with reference to FIG. 4C, the marine electronics device 320 may include a live page 325b, displaying an image of fish 321 within the livewell. In some embodiments, the image may include the culling tags, and may display the indicators, thereby allowing the fisherman to view the fish 321 without leaving their current location. In some embodiments, the live page 325b may display current conditions 332 of the water within the livewell. In some embodiments, the current conditions 332 may include water temperature, dissolved oxygen content, number of fish, total characteristic value of the fish, water level, and/or other similar data.

In some embodiments, the livewell may comprise a camera configured to take a photograph of the fish at specified time increments. In some embodiments, the camera may be configured to take continuous video of the livewell for real time viewing of the fish within the livewell.

In some embodiments, the images and/or video of the livewell may be uploaded to external servers (e.g., a tournament server). The tournament server may be used to monitor the fishermen participating in the tournament, and enforce the rules, for example, a limited number of fish in the livewell, or allowable species of fish.

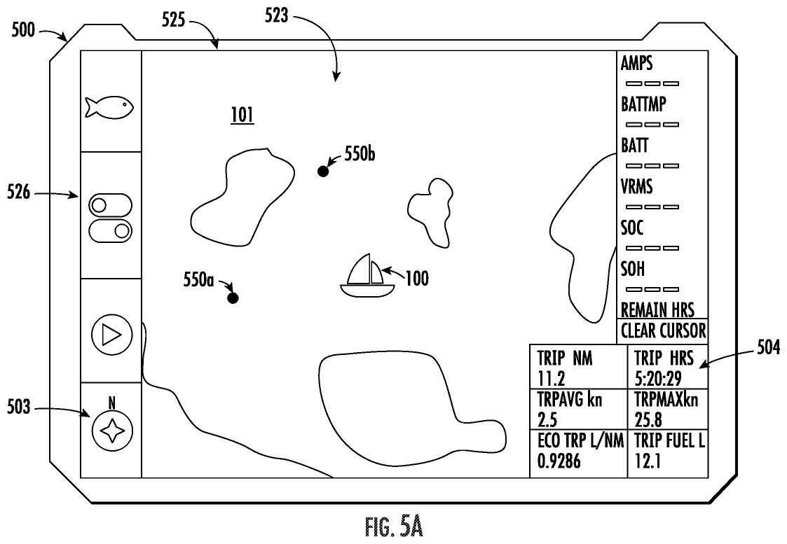

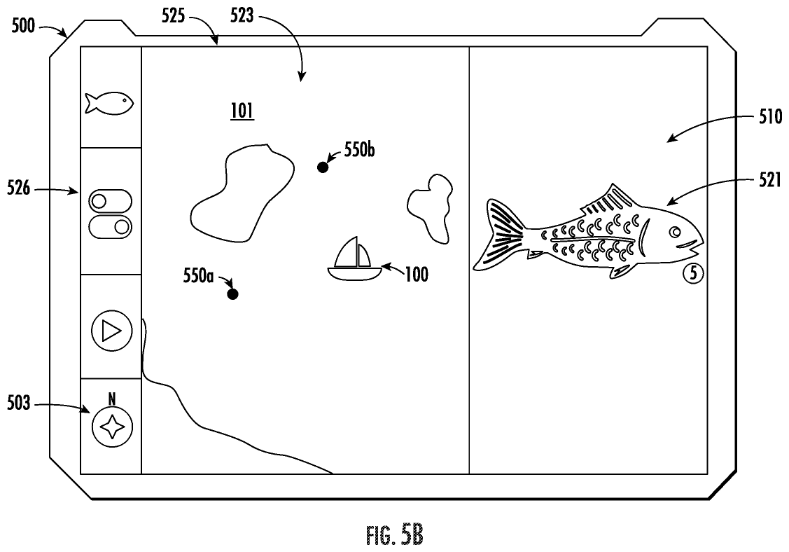

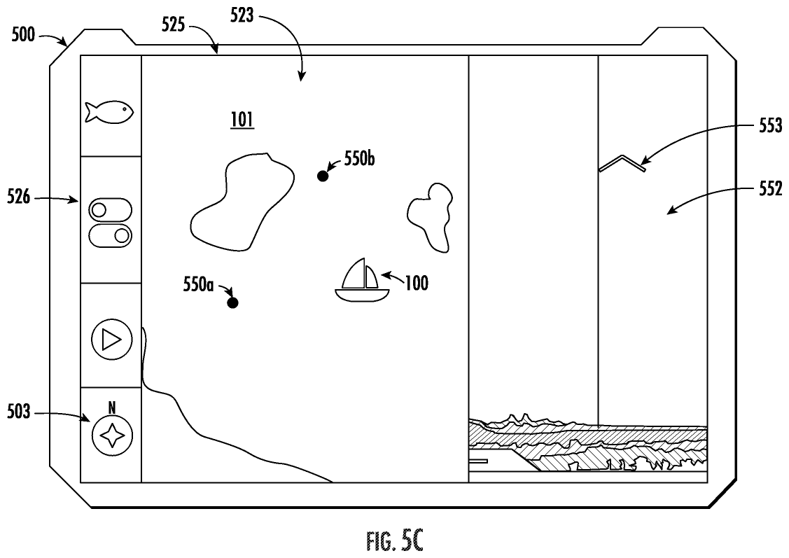

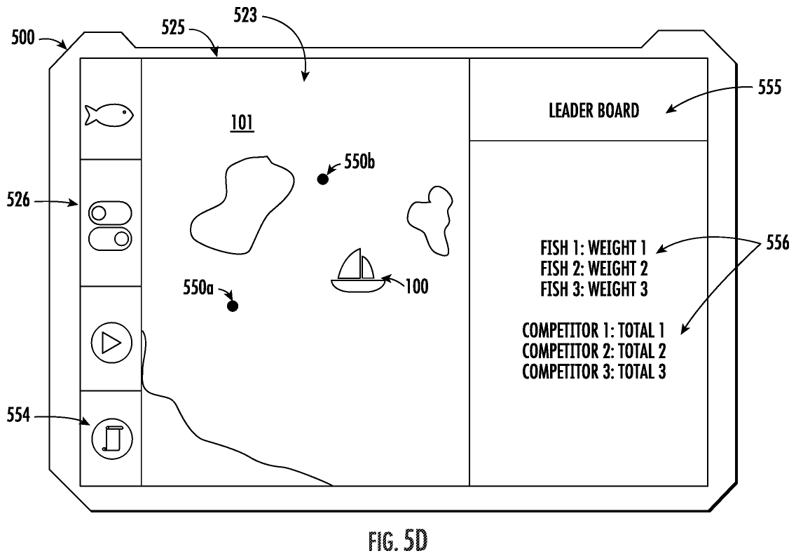

FIGS. 5A-D illustrate example pages presented on a display 525 of a marine electronics device 500. The marine electronics device 500 may present a chart 523 on the display 525. In some embodiments, the chart 523 may include a representation of the watercraft 100 at the current location on the body of water 101. In some embodiments, the display 525 may present data 504 corresponding to the trip, and/or the operation of the watercraft. For example, the data 504 may include the trip time, trip distance, average speed, current speed, fuel remaining, and/or other data.

In some embodiments, the marine electronics device 500 may enable toggling between display pages. The marine electronics device 500 may include toggle buttons 526. In some embodiments, the toggle buttons 526 may change the display page, and/or bring the display into a split screen to present different information on to the display 525. In some embodiments, the display 525 may present a compass position, such as at 503.

In some example embodiments, the marine electronic device 500 may be configured to receive an indication of a current location in response to the indication of a fish catch. The current location may be received from a position sensor, such as a global position system (GPS) sensor, or other positioning sensor associated with the marine electronic device 500. In an example embodiment, the marine electronic device 500 may generate a waypoint 550a, 550b at the current location on a navigational chart 523 of the body of water, such as depicted in FIG. 5B. In some example embodiments, the marine electronic device 500 may associate the characteristic data with the waypoint for the chart 523. The fisherman 102 may utilize the fish catch location waypoint(s) 550a, 550b and/or fish data to demonstrate the location of each fish catch, for tournament purposes, such as in which there is a predefined fishing area. Additionally or alternatively, the fisherman 102 may utilize the waypoints 550a, 550b and associated fish data for analytics or planning a future fishing expedition. Such waypoints may also be used to aid a fisherman in returning to a fish catch location, such as for releasing the fish back into its home water environment. That scenario may be aided by the correlation of the waypoint with the culling tag for the fish, such as described herein. Such travel may be tracked and verified, such as in accordance with state and/or tournament rules/regulations or the like.

In some embodiments, the chart 523 may include waypoints 550a, 550b. In some embodiments, the waypoints 550a, 550b may be the location where one or more fish was caught. In some embodiments, the fisherman may select a waypoint 550a, 550b, and the display may present the data about the one or more fish caught. In some embodiments, the data may include the characteristic value, an image, and/or other fish characteristic data. In some embodiments, other fish characteristic data may include the time of catch, the conditions of the water at the time of the catch, weather conditions at the time of the catch, etc.

In some embodiments, as illustrated in FIG. 5B selecting the waypoint 550a may cause the display 525 to divide into multiple portions, one portion presenting the chart 523, and a second portion 510 presenting an image of the fish 521. In some embodiments, the image of the fish 521 may include the characteristic data of the fish including the weight, length, and/or species of the fish. In some embodiments, the second portion 510 may present other information about the fish 521 and catch conditions as discussed above.

In some embodiments, as illustrated in FIG. 5C, selecting the waypoint 550a may cause the display 525 to divide to present the chart 523, and one or more sonar image(s) 552 corresponding to the fish catch. In some embodiments, the sonar image(s) 522 may include one or more fish indications 553. In some embodiments, the sonar image(s) may indicate the number of fish in that location at the time, and/or the activities surrounding the fish at the time of catch.

In some embodiments, as illustrated in FIG. 5D, the display 525 may be divided between the chart 523 and a leaderboard 555. In some embodiments, for example, in a fishing tournament, a fisherman may desire to know how their current caught fish compare to fish caught by other competitors 556. Thus, the marine electronics device 500 may be in data communication with an external server (e.g., a tournament server), and may retrieve data about other competitors to determine the various rankings.

In some embodiments, the leaderboard may present one or more of the categories being used to judge the tournament, for example, total characteristic weight, or single largest characteristic weight. In some embodiments, the leaderboard may present only indications of the competitor in the lead, while in other embodiments, the leaderboard may only present an indication of the value of the characteristic value in the lead on the leaderboard.

### Example System Architecture

FIG. 6 shows a block diagram of an example marine electronics device 420. The marine electronics device 420 may include a number of different modules or components, each of which may comprise any device or means embodied in either hardware, software, or a combination of hardware and software configured to perform one or more corresponding functions. The marine electronics device 420 may also be in communication with an autopilot 481, culling tags 440, the livewell 410 including pumps and valves 412, camera 416, temperature sensor 418b, oxygen sensor 418a, a transducer assembly 406, a characteristic sensor 460, or an external network 490. In an example embodiment, the marine electronic device 420 may comprise a user device, such as the mobile computing device 104 discussed above in reference to FIG. 1. In some example embodiments, the marine electronics device 420 may include a laptop computer, a tablet computer, a smart phone, personal data assistant (PDA), or the like.

The marine electronics device 420 may also include one or more communications modules configured to communicate with one another in any of a number of different manners including, for example, via a network. In this regard, the communications module may include any of a number of different communication backbones or frameworks including, for example, Ethernet, the NMEA 2000 framework, GPS, cellular, WiFi, or other suitable networks. The network may also support other data sources, including GPS, autopilot, engine data, compass, radar, etc. Numerous other peripheral devices such as one or more wired or wireless multi-function displays may be included in the marine data system 400.

The marine electronics device 420 may include a processor 470, a memory 474, a user interface 480, a display 482, a camera 484, one or more sensors (e.g. position sensor 483, characteristic sensor 460, etc.), and a communication interface 476.

The processor 470 may be any means configured to execute various programmed operations or instructions stored in a memory device such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor 470 described herein. In this regard, the processor 470 may be configured to analyze electrical signals communicated thereto to provide or receive sonar data, sensor data, location data, and/or additional environmental data. For example, the processor 470 may be configured to receive an indication of a fish catch from a user (e.g. from the user interface 480). Additionally or alternatively, the processor 470 may be configured to cause one or more events in response to the fish catch, such as filling a livewell and/or recirculating the livewell. In some embodiments, the processor 470 may be further configured to receive fish characteristic data associated with the fish catch and cause association of the fish data with one or more culling tags, such as described herein.

The memory 474 may be configured to store instructions, computer program code, marine data, such as sonar data, fish characteristic data, chart data, location/position data, and other data in a non-transitory computer readable medium for use, such as by the processor.

The communication interface 476 may be configured to enable connection to external systems (e.g. an external network 490). In this manner, the marine electronics device 420 may retrieve stored data from a remote, external server via the external network 490 in addition to or as an alternative to the onboard memory 474.

The position sensor 483 may be configured to determine the current position and/or location of the marine electronics device 420 and/or watercraft. For example, the position sensor 483 may comprise a GPS, bottom contour, inertial navigation system, such as machined electromagnetic sensor (MEMS), a ring laser gyroscope, or other location detection system.

The display 482, e.g. screen, may be configured to display images and may include or otherwise be in communication with a user interface 480 configured to receive input from a user. The display 482 may be, for example, a conventional LCD (liquid crystal display), a touch screen display, mobile device, or any other suitable display known in the art upon which images may be displayed.

In some embodiments, the display 482 may present one or more sets of marine data (or images generated from the one or more sets of data). Such marine data may include, for example, chart data, fish characteristic data, radar data, weather data, location data, position data, orientation data, sonar data, or any other type of information relevant to the watercraft. In some embodiments, the display 482 may be configured to present such marine data simultaneously as one or more layers or in split-screen mode. In some embodiments, a user may select any of the possible combinations of the marine data for display.

The user interface 480 may include, for example, a keyboard, keypad, function keys, mouse, scrolling device, input/output ports, touch screen, or any other mechanism by which a user may interface with the system.

Although the display 482 of FIG. 6 is shown as within the marine electronics device 420, the display 482 could alternatively be remote from the processor 470 and/or marine electronics device 420. Likewise, in some embodiments, the position sensor 483 and/or user interface 480 could be remote from the marine electronic device 420. Similarly, the autopilot 481 is depicted remote from the marine electronics device 420, but may be directly connected to the processor 470 within the marine electronics device 420.

The characteristic sensor 460 may be remote from the marine electronics device 420. In some embodiments, one of the characteristic sensors 460, for example a weight sensor 461 may be remote from the marine electronics device 420, while a length sensor 462 and/or the species identifier 463 may be directly connected to the processor 470 of the marine electronics device 420.

In an example embodiment, the marine electronics device 420 may include one or more cameras 484. The camera(s) 484 may be configured to capture one or more fixed or moving images. In some example embodiments, the camera(s) 484 may be configured to capture one or more images of a fish associated with a fish catch. The marine electronics device 420 may be configured to extract fish characteristic data based on the captured images including the fish.

In some embodiments, one or more sensors associated with the livewell 410, for example the pumps and valves 412, the camera 416, the temperature sensor 418b and/or the oxygen sensor such as described with reference to FIG. 4B, may be utilized to monitor and control one or more parameters of the livewell 410.

In an example embodiment, the marine electronic device 420 may be configured to monitor and/or control operation of one or more livewell pumps and/or valves 412. The marine electronic device 420 may control the fill pump and/or the recirculation pump. The marine electronic device 420 may control a power switch such as a relay or transistor to selectively supply power to the livewell pumps. Additionally, the marine electronics device 420 may be configured to control and/or monitor the operation of the fill valve and/or the purge valve. For example, the marine electronics device 420 may be configured to control power to a solenoid or servomechanism to change the position of the livewell valves.

A transducer assembly 406 may be in communication with the marine electronics device 420. In this regard, the transducer assembly 406 may be in a housing and configured to gather sonar data from the underwater environment surrounding the watercraft. In some embodiments, the transducer assembly 406 may include various sensors 465 including a motion sensor and/or other sensors. Accordingly, the processor 470 (such as through execution of computer program code) may be configured to receive sonar data from the transducer assembly 406 and process the sonar data to generate an image based on the gathered sonar data. In some example embodiments, the marine data system 400 may use the transducer assembly 406 to determine depth and bottom topography, detect fish, locate wreckage, etc. Sonar beams, from one or more transducer elements or arrays 446, 447 may be transmitted into the underwater environment and echoes can be detected to obtain information about the environment. In this regard, the sonar signals can reflect off objects in the underwater environment (e.g., fish, structures, sea floor bottom, etc.) and return to the transducer assembly 406, which converts the sonar returns into sonar return data that can be used to produce an image of the underwater environment. According to some example embodiments, transducer assembly 406 may include or be in communication with a display to render the image for display to a user.

In some embodiments, the transducer assembly 406 may utilize multiple sonar transducer arrays 466, 467. Each sonar transducer array 466, 467 may be oriented in a distinct direction relative to the watercraft and may emit one or more sonar beams according to an associated beam shape. In some embodiments, all of the sonar transducers arrays may have the same beam shape, while in other embodiments some of or all of the sonar transducers arrays may have distinct beam shapes. Each sonar transducer array may have a coverage volume, which correlates to the theoretical volume of water that its corresponding one or more sonar beams cover.

In some embodiments, the marine electronics device 420 may be in communication with the culling tag 440. In some embodiments, the culling tag 440 may include a computer-readable indicator 491, for example, a bar code or a computer readable chip. A user device may read the computer-readable indicator and gather information stored on a server (e.g., via the marine electronics device) regarding the corresponding fish. In some embodiments, the computer-readable indicator 491 may unlock the user interface 480 or the display 482 to receive data to be correlated to the culling tag 440. In some embodiments, the culling tag 440 may be in communication directly with the processor 470. For example, the culling tag 440 may include a communication interface (e.g., transmitter, receiver, transceiver, etc.) that enables communication (e.g., wired or wireless) to the processor 470, such as through the communication interface 476.

A motion sensor may be in communication with the marine electronics device 420, but, in some cases, may be housed remotely, such as in a fishing rod, a wrist strap, smart watch or other wearable device, or the like. The motion sensor and/or the marine electronics device 420 may be configured to use the detected motion to determine motion patterns associated with catching a fish, such as based on the placement and read information of the sensor. For example, a motion sensor disposed in a wrist strap may be configured to detect sharp downward motion associated with setting a fishhook. In some embodiments, the motion sensor may also detect a rotational or oscillation motion associated with reeling in a fish.

The autopilot 481 may include processing circuitry, such as a processor and a memory, configured to operate a maneuvering system 494. The autopilot 481 may be configured to operate the maneuvering system automatically, e.g. without user interaction, causing the watercraft 100 to travel along a route, such as to a specified fishing location or along a shoreline. The autopilot 481 may generate instructions based on a current position, a programmed route, or the like to operate the maneuvering system 494.

The maneuvering system 494 may include one or more propulsion motors, or engines, including but not limited to, outboard motors, inboard motors, trolling motors, main engines, emergency propulsion motors, or the like. Additionally, the maneuvering system 494 may include one or more control surfaces, such as rudders, planes, or the like configured to steer the watercraft.

### Example Flowchart(s) and Operations

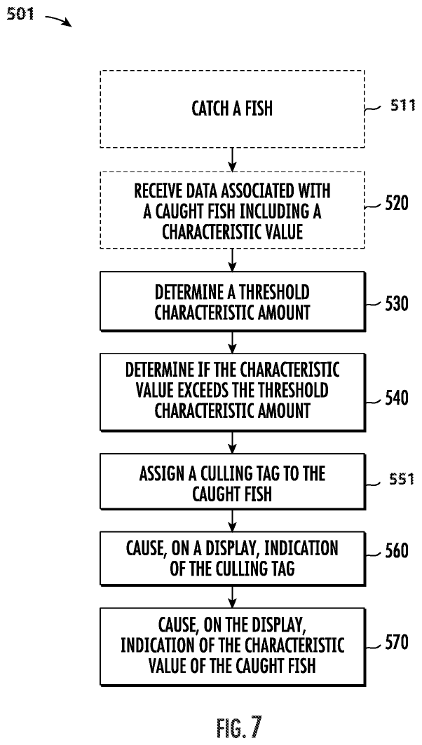

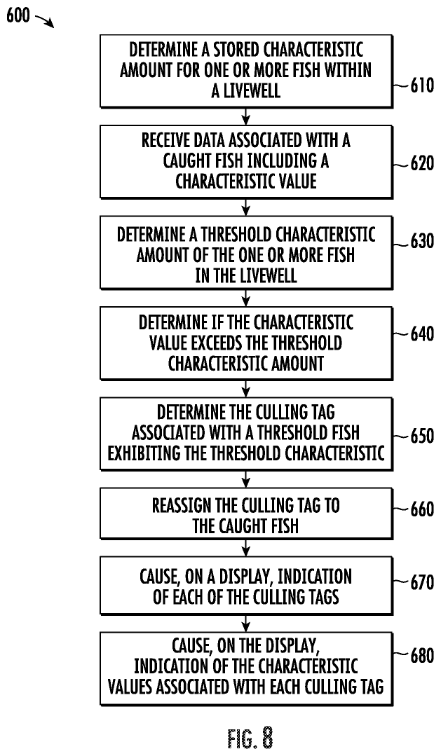

Embodiments of the present invention provide methods, apparatus and computer program products for operating and/or controlling one or more components of example embodiments, such as a livewell. Various examples of the operations performed in accordance with embodiments of the present invention will now be provided with reference to FIGS. 7-8.

FIGS. 7-8 illustrate flowcharts according to an example method for culling fish data according to an example embodiment. The operations illustrated in and described with respect to FIGS. 7-8 may, for example, be performed by, with the assistance of, and/or under the control of one or more of the processor 470, memory 474, communication interface 476, user interface 480, position sensor 483, characteristic sensor 460, camera 484, livewell 410, display 482, autopilot 481, culling tags 440, transducer assembly 406, autopilot 481, external network 490, and/or maneuvering system 494. A method 501 may optionally include catching a fish at operation 511 and receiving data associated with the first fish including a characteristic value at operation 520. The method 501 may also include determining a threshold characteristic amount (e.g., a lowest characteristic value of the fish held by the livewell) at operation 530, and determining if the characteristic value exceeds the threshold characteristic amount at operation 540. The method 501 may continue by assigning a culling tag to the first fish at operation 551, and causing, on a display, indication of the culling tag at operation 560. The method 501 may continue by causing, on the display, indication of the characteristic amount of the first fish at operation 570.

In another example embodiment, a method 600 may include determining a stored characteristic amount for one or more fish within a livewell at operation 610. The method 600 may include receiving data associated with the first fish including a characteristic value at operation 620. The method 600 may include determining a threshold chrematistic amount of the one or more fish in the livewell at operation 630 and determining if the characteristic value exceeds the threshold characteristic amount at operation 640. The method 600 may include determining the culling tag associated with a swap fish at operation 640, and reassigning the culling tag to the first fish at operation 660.

The method may continue by causing, on a display, indication of each of the culling tags at operation 670, and causing, on the display, indication of the characteristic values associated with each culling tag at operation 680.

FIGS. 7-8 illustrate flowcharts of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 474 and executed by, for example, the processor 470. As will be appreciated, any such computer program product may be loaded onto a computer or other programmable apparatus (for example, a marine electronics device 420 to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device (for example, a marine electronics device 420) to cause a series of operations to be performed on the computer or other programmable apparatus to produce a computer-implemented process such that the instructions which execute on the computer or other programmable apparatus implement the functions specified in the flowchart block(s).

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed:

1. A marine electronics device for a watercraft, the marine electronics device comprising:
a user interface comprising a display;
a processor and memory including computer program code, the computer program code configured to, when executed, cause the processor to:
receive data associated with a fish, wherein the received data includes an indication of a characteristic value of the fish, wherein the characteristic value is one of weight of the fish or length of the fish;
determine a threshold characteristic amount, wherein the threshold characteristic amount is associated with a livewell, wherein the livewell is configured to hold one or more fish, wherein each of the one or more fish held by the livewell has a stored characteristic value and is associated with a culling tag, wherein the threshold characteristic amount is equal to a minimum value of the stored characteristic values associated with the one or more fish held by the livewell;
determine if the characteristic value of the fish exceeds the threshold characteristic amount;
assign a culling tag to the fish, wherein the culling tag is associated with the characteristic value of the fish;
cause, on the display, indication of the culling tag and the stored characteristic value corresponding to the culling tag of each of the one or more fish held by the livewell.

2. The marine electronics device of claim 1, wherein the computer program code is further configured to, when executed, cause the processor to:
determine a maximum number of fish to be associated with the livewell;
determine if an addition of the fish exceeds the maximum number of fish; and
indicate, on the display, the culling tag associated with a swap fish when the addition of the fish exceeds the maximum number of fish, wherein the swap fish has a stored characteristic value corresponding to the threshold characteristic amount.

3. The marine electronics device of claim 2, wherein the computer program code is further configured to, when executed, cause the processor to:
receive an indication of a release of the swap fish; and
archive data associated with the swap fish.

4. The marine electronics device of claim 2, wherein the maximum number of fish is received from a manual entry.

5. The marine electronics device of claim 1, wherein the processor is in data communication with a measuring device, wherein the measuring device provides data associated with the fish, including the characteristic value.

6. The marine electronics device of claim 1, wherein the computer program code is further configured to, when executed, cause the processor to:
determine a current location of the watercraft associated with a location where the fish is caught; and
mark a waypoint associated with the location of the watercraft when the fish is caught.

7. The marine electronics device of claim 1, wherein the computer program code is further configured to, when executed, cause the processor to:
receive an indication of an oxygen level of water within the livewell from one or more oxygen sensors; and
cause a pump associated with the livewell to recirculate water in the livewell in response to determining that the oxygen level is below a predetermined oxygen threshold.

8. The marine electronics device of claim 1, wherein the computer program code is further configured to, when executed, cause the processor to:
receive an indication of a temperature of water within the livewell from one or more temperature sensors; and
cause a pump associated with a livewell to recirculate water in the livewell in response to determining that the temperature of the water is outside a predetermined temperature threshold.

9. The marine electronics device of claim 1, wherein the computer program code is further configured to, when executed, cause the processor to:
cause, on the display, presentation of an indication of at least one livewell characteristic on the display, wherein the at least one livewell characteristics is one of an oxygen level, a temperature, and the threshold characteristic amount.

10. The marine electronics device of claim 9, further comprising a camera, wherein the computer program code is further configured to, when executed, cause the processor to:
receive an image from the camera, wherein the image is of the livewell;
cause, on the display, presentation of the image; and
cause, on the display, presentation of the at least one livewell characteristic on the presentation of the image.

11. The marine electronics device of claim 1, wherein the culling tag defines an identifying characteristic, wherein the identifying characteristic is easily identifiable between the display and the livewell.

12. The marine electronics device of claim 11, wherein the identifying characteristic is at least one of a color or a number.

13. The marine electronics device of claim 1, wherein the computer program code is further configured to, when executed, cause the processor to:
determine a first user associated with a first livewell and a second user associated with a second livewell;
receive indication of the first user or the second user; and
associate the received fish data with the indicated first or second user.

14. The marine electronics device of claim 1, wherein the computer program code is further configured to, when executed, cause the processor to:
determine a total characteristic value, wherein the total characteristic value, is a sum of the stored characteristic values of the one or more fish held by the livewell; and
export the total characteristic value to a database, wherein the database is associated with a tournament.

15. The marine electronics device of claim 1, wherein the computer program code is further configured to, when executed, cause the processor to:
cause, on the display, each of the stored characteristic values of the one or more fish held by the livewell; and
order the presentation of the one or more fish based on the stored characteristic values.

16. A non-transitory computer-readable medium having stored thereon a plurality of computer-executable instructions which, when executed, cause a processor to:
receive data associated with a fish, wherein the received data includes an indication of a characteristic value of the fish, wherein the characteristic value is one of weight of the fish or length of the fish;
determine a threshold characteristic amount, wherein the threshold characteristic amount is associated with a livewell, wherein the livewell is configured to hold one or more fish, wherein each of the one or more fish held by the livewell has a stored characteristic value and is associated with a culling tag, wherein the threshold characteristic amount is equal to a minimum value of the stored characteristic values associated with the one or more fish held by the livewell;
assign a culling tag to the fish when the characteristic value exceeds the threshold characteristic amount; and
cause, on a display indication of the culling tag associated with the fish.

17. The non-transitory computer readable medium of claim 16, wherein the computer-readable medium instructions are further configured to, when executed, cause the processor to:
determine a swap fish from the one or more fish, wherein the swap fish has the stored characteristic value corresponding to the threshold characteristic amount; and
cause, on the display, presentation of tag information corresponding to the swap fish, wherein the tag information is at least one of a color or a number.

18. The non-transitory computer readable medium of claim 16, wherein the computer-readable medium instructions are further configured to, when executed, cause the processor to:
cause an indication when the received data associated with the fish is less than the threshold characteristic amount, wherein the indication alerts a user to release the fish.

19. The non-transitory computer readable medium of claim 16, wherein the computer-readable medium instructions are further configured to, when executed, cause the processor to:
cause, on the display, presentation of the stored characteristic value of each of the one or more fish held by the livewell and the culling tag corresponding to each of the one or more fish, wherein each of the culling tags displays an identifying characteristic, wherein the identifying characteristic is at least one of a color or a number,
wherein an order of the presentation of the stored characteristic values is based on a relative value of the stored characteristic value.

20. A method, the method comprising:
determining a characteristic value of a caught fish, wherein the characteristic value is one of weight of the fish or length of the fish;
determining a threshold characteristic amount, wherein the threshold characteristic amount is associated with a livewell, wherein the livewell is configured to hold one or more fish, wherein each of the one or more fish has a stored characteristic value and is associated with a culling tag, wherein the threshold characteristic amount is equal to a minimum value of the stored characteristic values associated with the one or more fish held by the livewell;
determining if the characteristic value of the fish exceeds the threshold characteristic amount;
assigning a culling tag to the fish, wherein the culling tag is associated with the characteristic value of the fish;
indicating a swap fish, wherein the swap fish has the threshold characteristic amount;
causing, on a display, indication of the culling tag and the stored characteristic value corresponding to the culling tag of each of the one or more fish held by the livewell.
